(19) United States
(12) Patent Application Publication
(10) Pub. No.: US 2007/0140751 A1
(43) Pub. Date: Jun. 21, 2007

(54) Fusing member temperature uniformity enhancement system

(75) Inventors: Yongsoon Eun, Webster, NY (US); Nicholas Kladias, Fresh Meadows, NY (US); Donald M. Bott, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/304,482

(22) Filed: Dec. 15, 2005

(51) Int. Cl. G03G 15/20

(52) U.S. Cl. 399/322

(57) ABSTRACT

A fusing system for use in a printing system is provided. In practice, a print media sheet having a size parameter value is transmitted to the fusing system along a first direction. Additionally, the print media sheet is provided with developer material prior to being delivered to the fusing system. The fusing system includes a fusing member positioned along a second direction for receiving the developed print media sheet. The second direction is substantially perpendicular to the first direction, and the fusing member is operated in accordance with a thermal profile that relates fusing temperature to the fusing member. The fusing system further includes a print media shifting control system for changing the position of the print media sheet relative to the fusing member in the second direction by a selected increment. The position changing of the print media sheet varies as a function of the size parameter value, and promotes uniformity in the thermal profile.

### BACKGROUND

The disclosed embodiments relate to an approach for controlling the shifting of different sized print media sheets relative to the cross-process direction of a heated fuser member for maintaining a substantially uniform temperature profile across the fuser roll member.

The xerographic imaging process is initiated by charging a photoconductive member to a uniform potential. An electrostatic latent image, corresponding with a print job, is then selectively discharged on the surface of the photoconductive member. A developer material is then brought into contact with the surface of the photoconductor to transform the latent image into a visible reproduction. The developer material includes toner particles with an electrical polarity opposite that of the photoconductive member, causing them to be naturally drawn to it. A blank media sheet is brought into contact with the photoreceptor and the toner particles are transferred to the sheet by the electrostatic charge of the media sheet. The toned or developed image is permanently affixed to the media sheet by subsequent application of heat to the sheet. The photoconductive member is then cleaned to remove any charge and/or residual developing material from its surface to prepare the photoconductive member for subsequent imaging cycles.

One preferred fusing method is to provide a heated fuser roll in pressure contact with a back-up roll or biased web member to form a nip. A print media sheet is passed through the nip to fix or fuse the toner powder image on the sheet. In one common example, the heated roll is heated by applying power to a heating element located internally within the fuser roll that extends the width of the fuser roll. The heat from the lamp is transferred to the fuser roll surface along the fusing area. Quartz lamps have been preferred for the heating element.

A typical printing system may be required to print on print media that can vary significantly in terms of, among other things, size. Depending on whether marking is being performed with respect to the long or short edge of a print media sheet, the width of smallest available print media to largest available print media sheet can differ by more than 400 mm or 16 inches. The typical fuser system is designed to accommodate a standard print media sheet width, and certain stresses are introduced at the fuser system as the width of the print media sheet introduced to the fuser system decreases relative to the standard.

It follows that introduction of different sized print sheets can increase the wear on the rolls of a fuser system. As indicated in U.S. Pat. No. 5,848,344, passing print media through the same section of a fuser roll nip throughout a printing operation can cause significant wear on the fuser system rolls in the area that contacts the print media. As suggested by the '344 Patent, a fuser wear algorithm may be incorporated into a registration module to incrementally change the transverse direction edge registration position of a print media sheet width depending upon the volume of print media passing through the fuser roll nip. That is, a fuser wear algorithm (the operation of which is not actually disclosed in the '344 Patent) could be used to shift the location of placement of a print media sheet along the cross process direction of the fuser rolls. This would distribute the wear of fuser rolls along a larger portion of their surfaces, thereby extending the life of these rolls.

U.S. Pat. No. 5,337,133 discloses a system for shifting a developed print media sheet, relative to the cross process direction of a fuser system, upstream of the fuser roll nip. According to the '133 Patent, fuser roll life is extended by varying image data placement on the photoreceptive member, and correspondingly varying image receiving substrate position so as to maintain proper location of the image data on the substrate while varying the transverse position of the substrate transverse to the paper path direction. As indicated in the '133 Patent, “[The] varying of lateral position of the sheet causes the high pressure, excessive wear area on the fuser roll to be distributed over a wider area on the roll and not concentrated at a single point at each edge of the sheet.”

It further follows that when print media sheets, having smaller width than typically encountered at the fuser system, are continuously introduced to the fuser system, excessive heat buildup can occur in those portions of the heated fuser roll that are out of contact with the print media sheet. More particularly, as a sheet passes over the heated fuser roll, that portion of the sheet contacting the roll absorbs heat and the temperature of the heated fuser roll portion contacted by the sheet is maintained at a target level for adequate fusing performance. Any portion of the heated fuser roll that is not touched by the sheet, however, can heat up excessively, thus leading to significant reduction in roll life and/or causing permanent damage to the roll. The problem can be compounded in low-mass “instant-on” systems where fuser rolls can have poor axial thermal conduction.

One solution to the problem of overheating in portions of the heated fuser roll can be achieved by halting printing until the heated roll has had sufficient time to cool down. In one Xerox printing system, when relatively narrow sheets are used, it is understood that pitches are skipped, pursuant to the marking process, so that roll portions untouched by the print media sheets (i.e., roll portions that would be subjected to overheating) are maintained at a suitable temperature.

Another temperature controlling approach is disclosed in U.S. Pat. No. 5,361,124 where a control circuit is provided for recognizing that shorter widths of print media are being used and for responsively lowering associated lamp temperature to prevent overheating. A further concept disclosed by the '124 Patent is to recognize the type of print media being used and to lower the lamp temperature in response to selection of print media of different fusing characteristics.

In yet another approach, a fusing system in which different sized lamps could be corresponded with different sized media sheets to minimize overheating is contemplated. For instance a shorter lamp might be used to accommodate a shorter sized sheet, and a longer lamp might be used to accommodate a longer sized sheet.

It can be readily appreciated that an approach of slowing down printing leads to a loss in productivity, and that the cost and/or complexity of a printing system could be significantly increased by either using multiple lamps or the addition of a system dedicated to controlling temperature as a function of media width. It would be desirable to provide a fusing system that minimizes overheating for relatively narrower print media sheets without the need to change the temperature of the heated fuser roll through either decreasing system productivity or adjusting temperature level with a dedicated control system.

### SUMMARY

In accordance with one aspect of the disclosed embodiments there is provided a fusing system for use in a printing system in which a print media sheet having a size parameter value is transmitted to the fusing system along a first direction. The print media sheet is provided with developer material prior to being delivered to the fusing system, and the fusing system comprises: at least one fusing member capable of being heated to a selected fusing temperature and having a fusing member length, said fusing member length being positioned along a second direction and receiving the developed print media sheet, wherein the second direction is substantially perpendicular to the first direction, and wherein said at least one fusing member is operated in accordance with a thermal profile that relates fusing temperature to fusing member length; and a print media shifting control system for changing the position of the print media sheet relative to said fusing member in the second direction by a selected increment, said position changing of the print media sheet (a) varying as a function of the size parameter value, and (b) promoting uniformity of said thermal profile.

In accordance with another aspect of the disclosed embodiments there is provided a method of fusing prints in a printing system in which a print media sheet having a size parameter value is transmitted to the fusing system along a first direction. The print media sheet is provided with developer material prior to being delivered to the fusing system, and the fusing method comprises: delivering the developed print media sheet to a fuser member capable of being heated to a selected fusing temperature and having a fusing member length; positioning the fusing member length along a second direction, the second direction being substantially perpendicular to the first direction; operating the fusing member in accordance with a thermal profile that relates fusing temperature to fusing member length; and changing the position of the print media sheet relative to the fusing member in the second direction by a selected increment, said changing (a) varying as a function of the size parameter value, and (b) promoting uniformity in said thermal profile.

In accordance with yet another aspect of the disclosed embodiments there is provided a method of fusing prints in which a first set of print media sheets with a first number of sheets is transmitted to the fusing system during a first time interval and a second set of print media sheets with a second number of sheets is transmitted to the fusing system during a second time interval. Each one of the print media sheets is transmitted in a first direction and provided with developer material prior to being delivered to said fusing system, and the fusing method comprises: delivering each one of the developed print media sheets to a fusing member capable of being heated to a selected fusing temperature and having a fusing member length; positioning the fuser member along a second direction, the second direction being substantially perpendicular to the first direction; operating the fuser member in accordance with a thermal profile that relates fusing temperature to fusing member length; changing (a) the position of the first print media sheet set relative to the fusing member in the second direction by a first increment, (b) the position of the second print media sheet set relative to the fusing member in the second direction by a second increment; and selecting each one of the first number of print media sheets and the second number of print media sheets to maintain a substantially flat thermal profile.

### BRIEF DESCRIPTION OF THE DRAWINGS

FIG. 1 is a schematic elevational view of a printing system including a contact fusing device having a heated fuser roll with a back-up roll;

FIG. 2 is a perspective view of some of the principal components of FIG. 1 that support a fuser roll temperature uniformity enhancement system of the disclosed embodiments;

FIG. 3 is a perspective view of the heated fuser and back-up rolls being moved along a cross process direction;

FIG. 4 is a perspective view of the heated fuser and back-up rolls with a relatively narrow print media sheet being positioned, relative to the rolls, in the cross process direction;

FIG. 5 is a flow diagram for an algorithm to determine one or more shift increments (relative to a nominal registration reference), as required, and the number of print media sheets in each shifted print media sheet set; and

FIG. 6 is a graphical representation of temperature profiles associated with two fusing simulation cases, the first case being with A6 print sheets edge registered relative to the outboard side of a heated fusing roll, and the second case being with A6 sheets shifted relative to the cross process direction of the roll in accordance with the approach of the disclosed embodiments.

### DESCRIPTION OF DISCLOSED EMBODIMENTS

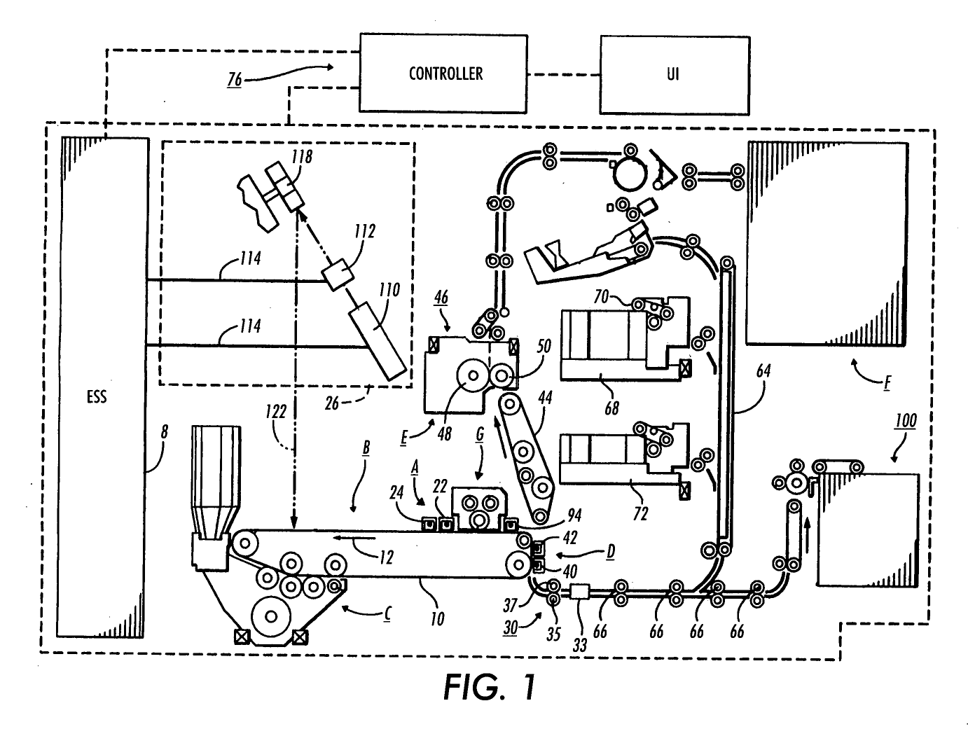

Referring to FIG. 1 of the drawings, an electrophotographic printing machine, employing a photoconductive belt 10, is shown. Belt 10 moves in the direction of arrow 12 to advance successive portions sequentially through the various processing stations disposed about its path of movement.

Initially, a portion of the photoconductive surface passes through charging station A. At charging station A, two corona generating devices indicated generally by the reference numerals 22 and 24 charge the photoconductive belt 10 to a relatively high, substantially uniform potential. Corona generating device 22 places all of the required charge on photoconductive belt 10. Corona generating device 24 acts as a leveling device, and fills in any areas missed by corona generating device 22.

Next, the charged portion of the photoconductive surface is advanced through imaging station B. At the imaging station, an imaging module indicated generally by the reference numeral 26, records an electrostatic latent image on the photoconductive surface of the belt 10. Imaging module 26 includes a raster output scanner (ROS). The ROS lays out the electrostatic latent image in a series of horizontal scan lines with each line having a specified number of pixels per inch.

In the disclosed embodiment of FIG. 1, the imaging module 26 (ROS) includes: a laser 110 for generating a collimated beam of monochromatic radiation 122; an electronic subsystem (ESS) 8, cooperating with the machine electronic printing controller 76 that transmits a set of signals via 114 corresponding to a series of pixels to the laser 110 and/or modulator 112; a modulator and beam shaping optics unit 112, which modulates the beam 122 in accordance with the image information received from the ESS 8; and a rotatable polygon 118 having mirror facets for sweep deflecting the beam 122 into raster scan lines which sequentially expose the surface of the belt 10 at imaging station B.

Thereafter, belt 10 advances the electrostatic latent image recorded thereon to a development station C. As is well known, the development station C includes a unit in which developer material (including toner particles and carrier granules) is housed. The latent image attracts toner particles from the carrier granules of the developer material to form a toner powder image on the photoconductive surface of belt 10. Belt 10 then advances the toner powder image to transfer station D.

At transfer station D, a print media sheet is moved into contact with the toner powder image. First, photoconductive belt 10 is exposed to a pre-transfer light from a lamp (not shown) to reduce the attraction between photoconductive belt 10 and the toner powder image. Next, a corona generating device 40 charges the print media sheet to the proper magnitude and polarity so that the print media sheet is tacked to photoconductive belt 10 and the toner powder image attracted from the photoconductive belt to the print media sheet. After transfer, corona generator 42 charges the print media sheet to the opposite polarity to detack the print media sheet from belt 10. Conveyor 44 advances the print media sheet to fusing station E.

Fusing station E includes a fuser assembly indicated generally by the reference numeral 46. The fusing station causes the transferred toner powder image to be permanently affixed to the print media sheet. In one embodiment, fuser assembly 46 includes a heated fuser roller 48 and a pressure roller 50 with the powder image on the print media sheet contacting fuser roller 48. The pressure roller is cammed against the fuser roller to provide the necessary pressure to fix the toner powder image to the print media sheet. The fuser roll may be internally heated by a quartz lamp. In one example, release agent, stored in a reservoir, is pumped to a metering roll. A trim blade trims off the excess release agent, and the release agent is transferred to the fuser roll by way of a donor roll. It will be appreciated that the improved fuser system disclosed herein could be used with a variety of fuser types without altering the concepts upon which such improved fuser system is based. For instance, it may be advantageous to use belts instead of rolls, or with a heat pipe fuser roll instead of a lamp heated roll

Print media sheets may be fed to transfer station D from the secondary tray 68. The secondary tray 68 includes an elevator driven by a bidirectional AC motor. Its controller has the ability to drive the tray up or down. When the tray is in the down position, stacks of print media sheets are loaded thereon or unloaded therefrom. In the up position, successive print media sheets may be fed therefrom by sheet feeder 70. Sheet feeder 70 is a friction retard feeder utilizing a feed belt and take-away rolls to advance successive print media sheets to transport 64 which advances the print media sheets to rolls 66 and then to transfer station D.

The print media sheet is registered just prior to entering transfer station D so that the sheet is aligned to receive the developed image thereon. In the present embodiment, the print media sheet is registered by way of a nonfixed edge registration device 30. A particularly effective device is shown and described in U.S. Pat. No. 5,219,159, the pertinent portions of which are incorporated herein by reference. This registration device utilizes a translating set of drive nips together with a stepper motor to accurately locate and position a registration edge. As will be described further, the registration position can be varied laterally with such a device to achieve the objectives of the disclosed embodiments. Alternatively, a registration device utilizing a laterally shiftable hard registration edge could also provide the necessary sheet offset.

Print media sheets may also be fed to transfer station D from the auxiliary tray 72. As contemplated in one embodiment, secondary tray 68 and auxiliary tray 72 are secondary sources of print media sheets, while a high capacity variable sheet size sheet feeder, indicated generally by the reference numeral 100, is the primary source of print media sheets.

Invariably, after the print media sheet is separated from the photoconductive belt 10, some residual particles remain adhering thereto. After transfer, photoconductive belt 10 passes beneath corona generating device 94 that charges the residual toner particles to the proper polarity. Thereafter, the pre-charge erase lamp (not shown), located inside photoconductive belt 10, discharges the photoconductive belt in preparation for the next charging cycle. Residual particles are removed from the photoconductive surface at a conventional cleaning station G.

A generally conventional programmable controller 76 preferably controls, among other things, all xerographic imaging sheet feeding and finishing operations. The controller 76 is additionally programmed with certain novel functions and graphic user interface (“Ul”) features for the general operation of the above-described electrostatographic printing system. The controller 76 may include a known programmable microprocessor system, such as described in U.S. Pat. No. 5,832,358, the pertinent portions of which are incorporated herein by reference, for controlling the operation of all of the machine steps and processes described herein. Thus, for example, when the operator selects the finishing mode, either an adhesive binding apparatus and/or a stapling apparatus will be energized and the gates will be oriented so as to advance either the simplex or duplex copy sheets to finishing station F.

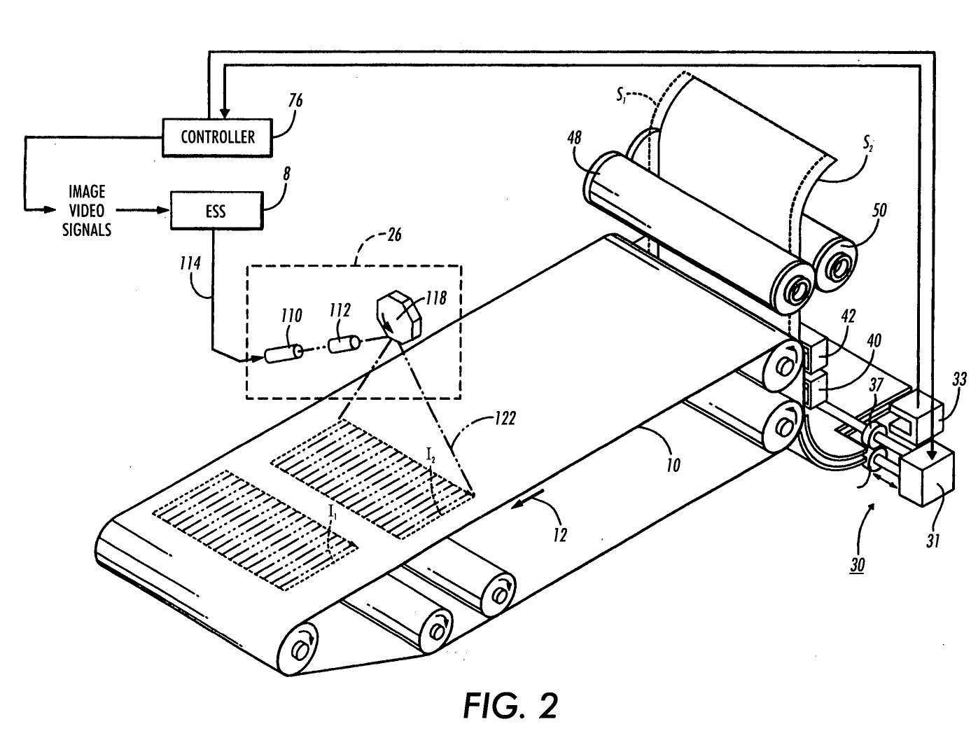

Turning now to FIG. 2, a perspective view of some of the principal components of a fuser roll temperature uniformity enhancement system is provided. In particular, the photoreceptor belt 10 is shown in conjunction with the ESS 8, ROS 26, controller 76, sheet registration device 30, transfer station D and fusing station rolls 48, 50—the heated fuser roll 48 and backup roll 50 are shown to provide context for the fuser roll temperature uniformity enhancement system. As can be seen, the ROS unit 26 receives a signal from the ESS and the rotating polygon causes a series of image data to be directed to the previously charged photoreceptive belt 10. As shown in FIG. 2, I₁ represents a first portion of image data and I₂ represents a second portion of image data located in a laterally offset position from the image data of image I₁. This offset is accomplished by utilizing a slight timing differential with respect to the signals sent from the ESS to the ROS imager. Alternatively, an LED light bar imaging system could be used in place of the ROS, in which event the image position transverse to the process direction would be varied across the width of the light bar.

In the example of FIG. 2, as the imaged areas 11 and 12 are advanced further around the belt in the direction of arrow 12, the images will be developed as described above and ultimately transferred to the substrate, represented in FIG. 2 by S₁ and S₂. S₁ corresponds to the position of the sheet that would receive the image data I₁ and S₂ corresponds to the sheet that would receive the image data I₂. Of course it will be recognized that positions I₁ and I₂ are representative only and many other incremental positions could be achieved.

When the image position is varied by the write source, the substrate position is, in accordance with the presently disclosed embodiment, varied transverse to the paper path direction a corresponding amount so that the image is properly placed on the substrate. A translating roll device 30, including (a) a drive roll 35 and an idler roll 37, both of which cooperate to form a drive nip, and (b) a mechanism 31 to move the drive nip transverse to the paper path direction in response to a signal from the machine controller, could be utilized to align the substrate with the image on the photoreceptor. As described in previously referenced U.S. Pat. No. 5,219,159, a sensor 33 may be positioned to detect when the edge of a sheet passes a certain lateral position. If a stepper motor is utilized to translate the drive nip, the sheet can be accurately positioned a predetermined number of steps to one side or another of the sensor, corresponding to the position of the image on the photoreceptor. Utilizing such an arrangement can allow the position of the images and the substrate to be varied over an area in increments as small as one step of the stepper motor. Further descriptive support regarding the variation of image position is provided in U.S. Pat. No. 5,337,133, the pertinent portions of which are incorporated herein by reference.

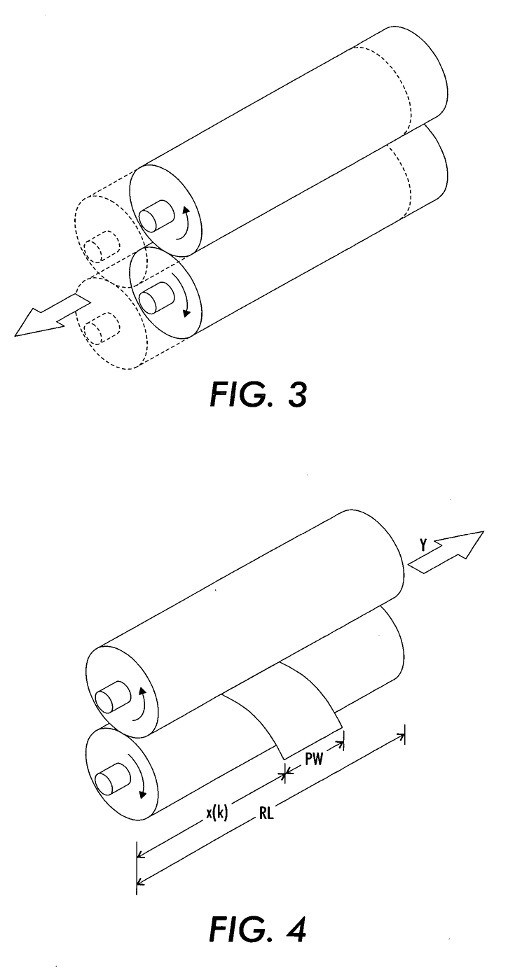

Referring now to FIG. 3, an alternative approach for changing the position of a print media sheet relative to the rolls 48, 50 is discussed briefly. In the contemplated approach of FIG. 3, the rolls are simultaneously shifted a preselected increment, in the direction of arrow 200, prior to receiving a set of one or more developed print media sheets. In this way, the steps of varying image position relative to the photoreceptor belt 10 (FIG. 2), and shifting print media sheets with translating roll device 30, are unnecessary. An arrangement for shifting rolls 48, 50 is provided in the Xerox's iGen3 (“iGen3” is a trademark of Xerox Corporation) 110 Digital Production Press.

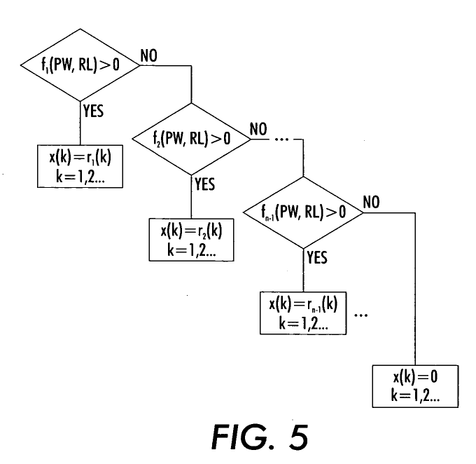

In view of the above description with respect to FIGS. 1-3, the subject fuser roll temperature uniformity enhancement system (and related method of use) can now be more fully comprehended. Referring specifically to FIG. 4, a perspective view in which the position of a developed print media sheet 202 that has been changed or shifted relative to the cross process direction of the heated fuser roll 48 is shown. To facilitate the description of FIG. 5 below, it should be noted that the few parameters shown in FIG. 4 are defined as follows:
x(k)=Shift from Nominal Registration Reference
PW=Paper Width
RL=Heated Fuser Roll Length

Referring now to FIGS. 3-5, the fuser roll temperature uniformity enhancement system contemplates an approach in which the developed print media sheet 202 is shifted in the Y direction (cross process direction) by, for example, either moving the rolls 48, 50 (FIG. 3) relative to the developed print media sheet, or offsetting a latent image and shifting the undeveloped print media sheet as explained above with respect to the description of FIGS. 1 and 2. The method by which the print media sheet is shifted along the cross process direction is not critical, provided each developed print media sheet can be shifted in accordance with the shifting algorithm below without smearing the developed image on the sheet.

Referring to FIG. 5, one example of a print media shifting algorithm includes functions, fᵢ(.)s and rᵢ(.)s, i=1 . . . n−1, where n−1 represents the number of print media width ranges for which shifting may be selected. As explained in further detail below, print media sheet widths selected for use with the fuser system 46 are respectively corresponded with functions fᵢ(.)s. Additionally, further information regarding shift increment, the number of print media sheets to be fused at a given increment, and the number of shift changes is obtained by calculation of the functions rᵢ(.)s.

In the exemplary approach of FIG. 5, the fᵢ(.)s are calculated with one input and three parameters. The input comprises PW, and two of the three parameters include RL and side margin (SM: the length of each unused end portion of the heated fuser roll 48). The third parameter, designated as “L,” is determined empirically and should be unique for each fᵢ(.). In the equation (1) set forth below, the value of L varies as a direct function of print media sheet width. It has been found that, for a selected value of PW, fᵢ(.) can be determined with the following equation (1):
fᵢ(.)=(RL−(2×SM))/L−PW, (1)

For the case in which the narrowest width corresponds with A6 media, f₁ is used to detect that PW is close to A6 size (110 mm). The values used for the A6 case are:
RL=325 mm
SM=12.5 mm
L=2.5

It will be readily recognized by those skilled in the art that L, for the above case, would be adjusted upward for the next contemplated print media sheet width (which would presumably have a less narrow width) so that f₂>0. For the example of FIG. 5, the L used in calculating f₂ should be such that f₁<0 and f₂>0 when the next contemplated print media is encountered by the system. This concept of selecting L so that the fᵢ(.) being mapped to a given sheet width is positive for the given sheet width and negative for narrower sheet widths is used in for mapping each desired sheet width to one of the decision diamonds 204-1, 204-2, 204-3, . . . 204-N.

Referring still to FIG. 5, for each fᵢ(.), an associated function rᵢ(.) is calculated to provide information about, among other things actual shifting—it should be noted that, as shown in FIG. 5, x(k) assumes the value of rᵢ(k), where k=1, 2, . . . . As an input, rᵢ(.) takes the page number k, so that, for page k (k-th sheet), the value of rᵢ(k) is the length of shift from the nominal sheet registration point. The rᵢ(.)s are characterized by three different parameters; namely increment of shift (“a”), the number of sheets to be fused before the amount of shift changes (“b”), and the number of different registration locations (“c”). It has been found that, rᵢ(k) may be calculated with the following equation (2):
rᵢ(k)=a (floor((k−1)/b) modular c) (2)

In the above equation (2), the function “floor(.)” causes a round-off operation to the nearest smaller integer, and the modular expression, assuming the form of “(x modular y),” describes a known modular operation. As is known by those skilled in the art, the value of (x modular y) is obtained by subtracting from x the largest multiple of y that is smaller than x. Accordingly, for integers x and y, the values assumed by (x modular y) are 0, 1, . . . y−1, and when y=3, (0 modular 3)=0, (1 modular 3)=1, (2 modular 3)=2, (3 modular 3)=0, (4 modular 3)=1, (5 modular 3), and so on.

The respective selections of a, b, and c are empirical, with the parameters a and c being selected to ensure uniform spatial use of the fuser rolls. The parameter b should be selected to (1) avoid overly frequent print media shifts that could result in component wear and fatigue, and yet (2) still ensure a reasonably uniform temperature profile across the heated fuser roll for a desired time interval. For a case employing A6 print media, the three parameters for r₁(k) comprise: a=100 mm, b=10, c=3. This results, r₁(k)=0 for k=1 to 10 (the first 10 pages), r₁(k)=100 or k=11 to 20, r₁(k)=200 for k=21 to 30, and r₁(k)=0 again for k=31 to 40, and so on.

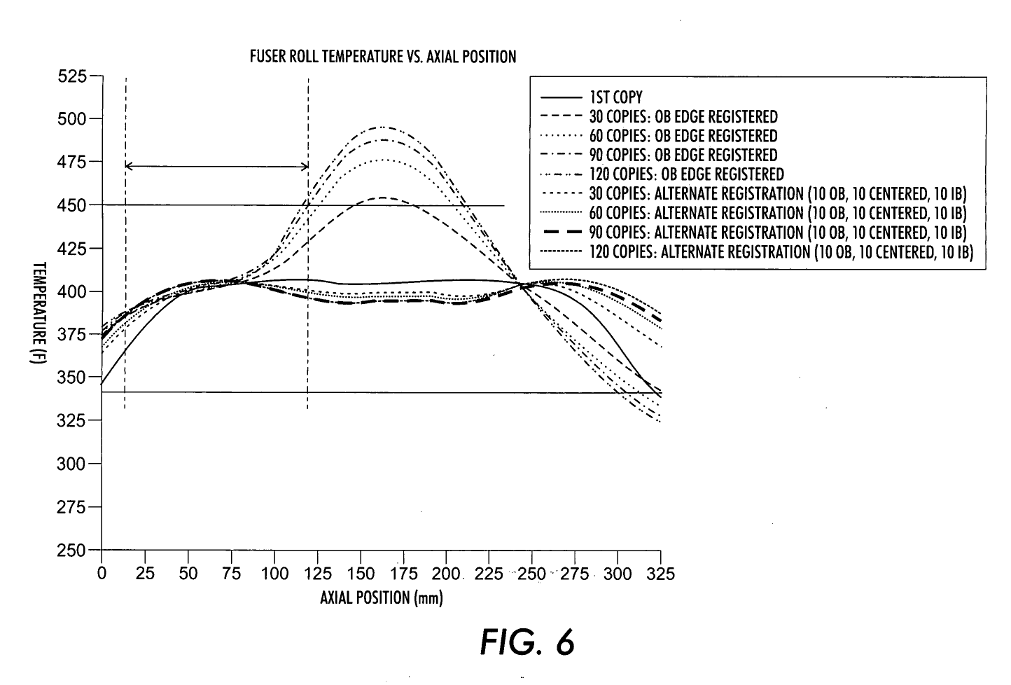

Referring finally to FIG. 6, simulation results demonstrating a benefit of the disclosed subject fuser roll temperature uniformity enhancement system are shown. Two cases were simulated with fuser simulation software for a 325 mm long fuser roll. In the first case, represented in the accompanying drawing of FIG. 6 as solid lines, 120 sheets of A6 paper were fused with all sheets edge registered at the outboard end of the heated fuser roll. As shown in the accompanying drawing, the temperature at the center of the roll begins to rise and, after fusing 120 prints, reaches approximately 100° F. higher than the outboard side. This spike in temperature inevitably leads to increased surface wear, debonding and other failure in the heated fuser roll 48. In the second case, A6 paper is shifted relative to the cross process direction of the heated fuser roll in accordance with the above-described algorithm. That is, registration of the developed sheets is alternated between outboard, center and inboard for every set of 10 sheets (i.e., the sequence repeats after causing 10 sheets to be fed outboard, 10 sheets to be fed center, and then 10 sheets to be fed inboard). Clearly, when using the fusing system improvement of the disclosed embodiments, there is a significantly noticeable improvement in temperature uniformity across the fuser roll between the two cases.

It should be appreciated that the above-disclosed fusing system improvement might be advantageously used in a tandem printing environment (e.g., a printer using multiple, coordinated print engines). More particularly, since the improvement employs an image move along with a lateral print media sheet shift, and since a typical tandem printing system already performs such image move and lateral sheet shift, pursuant to engine-to-engine registration, the platform necessary for implementing the improvement would apparently already be present in the typical tandem printing system without any additional cost.

In view of the above description, it should appear that a fusing system for promoting a uniform thermal profile when fusing relatively narrow print media sheet sizes is provided. One advantageous feature of the disclosed embodiments is an algorithm that accommodates for shifting a wide range of sheet widths. As contemplated, many different sheet widths can be mapped to a respective number of functions fᵢ(.).

For each fᵢ, a corresponding function rᵢ can be used to determine further information regarding shift increment, the number of print media sheets to be fused at a given increment, and the number of shift changes. The appropriate determination of this information serves to 1) avoid overly frequent print media shifts that could result in component wear and fatigue, and yet (2) still ensure a reasonably uniform temperature profile across the heated fuser roll for a desired time interval.

Another advantageous feature of the disclosed embodiments is that a uniform thermal profile can be achieved without losing productivity or significantly increasing associated printing system cost and/or complexity. That is, productivity is maintained at a desirable level since the heat source for the fusing system need not be adjusted downward to avoid overheating. Additionally, the cost associated with sheet shifting need not be significant, particularly in printing systems already having sheet shifting capability, such as a printing system with either translating fusing system rolls or a sheet shifting capable transfer station.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A fusing system usable with a printing system in which a print media sheet having a size parameter value is transmitted to the fusing system along a first direction, wherein the print media sheet is provided with developer material prior to being delivered to the fusing system, said fusing system comprising:
at least one fusing member capable of being heated to a selected fusing temperature and having a fusing member length, said fusing member length being positioned along a second direction and receiving the developed print media sheet, wherein the second direction is substantially perpendicular to the first direction, and wherein said at least one fusing member is operated in accordance with a thermal profile that relates fusing temperature to fusing member length; and
a print media shifting control system for changing the position of the print media sheet relative to said fusing member in the second direction by a selected increment, said position changing of the print media sheet (a) varying as a function of the size parameter value, and (b) promoting uniformity of said thermal profile.

2. The fusing system of claim 1, in which the print media sheet includes a width, wherein said size parameter value comprises print media sheet width.

3. The fusing system of claim 1, in which said position changing of the print media sheet further varies as a function of fusing member length.

4. The fusing system of claim 1, further comprising a print media sheet-shifting device for implementing said position changing of the print media sheet.

5. The fusing system of 1, wherein said position changing of the print media sheet is implemented by repositioning of the fusing member in the second direction.

6. The fusing system of claim 1, in which (a) another print media sheet having another size parameter value is transmitted to the fusing system along the first direction, (b) the other print media sheet is provided with developer material prior to being delivered to the fusing system, and (c) said fusing member receives the other developed print media sheet, wherein said print media shifting control system changes the position of the other print media sheet relative to said fusing member in the second direction by another selected increment, said changing of said print media shifting control system varying as a function of another size parameter value.

7. The fusing system of 1, wherein said control system uses an equation for calculating said selected increment.

8. A method of fusing prints in a printing system in which a print media sheet having a size parameter value is transmitted to the fusing system along a first direction, wherein the print media sheet is provided with developer material prior to being delivered to the fusing system, said fusing method comprising:
delivering the developed print media sheet to a fuser member capable of being heated to a selected fusing temperature and having a fusing member length;
positioning the fusing member length along a second direction, the second direction being substantially perpendicular to the first direction;
operating the fusing member in accordance with a thermal profile that relates fusing temperature to fusing member length; and
changing the position of the print media sheet relative to the fusing member in the second direction by a selected increment, said changing (a) varying as a function of the size parameter value, and (b) promoting uniformity in said thermal profile.

9. The method of claim 8, in which the print media sheet includes a width, wherein said method includes configuring the size parameter as a print media sheet width.

10. The fusing method of claim 8, further comprising causing said changing to vary as a function of fusing member length.

11. The fusing method of claim 8, in which the fusing member is stationary, wherein said changing includes shifting the print media sheet relative to the stationary fusing member.

12. The fusing method of claim 8, wherein said changing includes repositioning of the fusing member in the second direction

13. The fusing method of claim 8, in which (a) another print media sheet having another size parameter value is transmitted to the fusing system along the first direction, (b) the other print media sheet is provided with developer material prior to being delivered to the fusing system, and (c) said fusing member receives the other developed print media sheet, wherein said changing further includes changing the position of the other print media sheet relative to the fusing member in the second direction by another selected increment, wherein said changing the position of the other print media sheet relative to the fusing member varies as a function of another size parameter value.

14. The method of claim 8, wherein said changing includes using an equation for calculating said selected increment.

15. A method of fusing prints in which a first set of print media sheets with a first number of sheets is transmitted to the fusing system during a first time interval and a second set of print media sheets with a second number of sheets is transmitted to the fusing system during a second time interval, wherein each one of the print media sheets is transmitted in a first direction and provided with developer material prior to being delivered to said fusing system, said fusing method comprising:
delivering each one of the developed print media sheets to a fusing member capable of being heated to a selected fusing temperature and having a fusing member length;
positioning the fuser member along a second direction, the second direction being substantially perpendicular to the first direction;
operating the fuser member in accordance with a thermal profile that relates fusing temperature to fusing member length;
changing (a) the position of the first print media sheet set relative to the fusing member in the second direction by a first increment, (b) the position of the second print media sheet set relative to the fusing member in the second direction by a second increment; and
selecting each one of the first number of print media sheets and the second number of print media sheets to maintain a substantially flat thermal profile.

16. The method of claim 15, further comprising determining the first and second increments with a relative position change program.

17. The method of 16, wherein said determining includes providing a function that varies as a function of either print media sheet width or fusing member length.

18. The method of claim 15, where said changing is implemented with a print media sheet-shifting device.

19. The method of 15, wherein said changing is implemented by repositioning of the fusing member in the second direction.

20. The fusing method of claim 15, wherein said selecting includes making the first number of print media sheets different than the second number of print media sheets.
